(19) United States
(12) Patent Application Publication
(10) Pub. No.: US 2026/0137069 A1
(43) Pub. Date: May 21, 2026

(54) SPRAYER NOZZLE DEVICES AND RELATED SYSTEM AND METHODS

(71) Applicant: Ag Leader Technology, Ames, IA (US)

(72) Inventor: John Howard, Ames, IA (US)

(21) Appl. No.: 19/396,099

(22) Filed: Nov. 20, 2025

Related U.S. Application Data
(60) Provisional application No. 63/722,934, filed on Nov. 20, 2024.

(51) Int. Cl. A01M 7/00; B05B 12/00; B05B 12/08

(52) U.S. Cl. CPC A01M 7/0089; A01M 7/0032; B05B 12/008; B05B 12/085

(57) ABSTRACT

A nozzle assembly for an agricultural sprayer comprising: a nozzle body having an inlet and an outlet; a pulse width modulation (PWM) nozzle valve disposed within the nozzle body and configured to modulate flow from the inlet; a spray tip mounted at the outlet downstream of the PWM nozzle valve; and a pressure sensor integrated within the nozzle body and positioned hydraulically between the PWM nozzle valve and the spray tip, the pressure sensor configured to measure pressure of liquid exiting the PWM nozzle valve, wherein the nozzle assembly is configured to communicate the measured pressure to a sprayer control system for closed-loop control of nozzle-exit pressure and droplet size.

### CROSS-REFERENCE TO RELATED APPLICATION(S)

This application claims the benefit under 35 U.S.C. § 119 (e) to U.S. Provisional Application 63/722,934, filed Nov. 20, 2024, and entitled Sprayer PWM Nozzle Valve Pressure Drop Mitigation, which is hereby incorporated herein by reference in its entirety for all purposes.

### TECHNICAL FIELD

The disclosure relates to agricultural spraying systems and some specifically to control systems therefor.

### BACKGROUND

Various agricultural sprayers and liquid application systems would be known and appreciated by those of skill in the art. An exemplary agricultural sprayer is shown in FIG. 1. In this known sprayer 2 the liquid product flows from a solution tank 4 to spray nozzles 10 for application. As would be understood, the sprayer 2 may include various additional components such as ball valves, filters, chemical inductors, agitation and rinse circuits, and the like, omitted in FIG. 1 for simplicity and clarity but would be understood and appreciated by those of skill in the art.

In this example, of a sprayer 2, a remote chemical supply tank 4 is connected to the fill port 6 such that the liquid product may be pumped into the liquid solution tank 4. A pump 8 is used to move the liquid from the liquid solution tank 4 to the spray nozzles 10, such as through boom plumbing 12.

In certain sprayers 2, the speed of the pump 8 may be varied to control the flow rate of liquid to meet the required volume of liquid applied. A flow meter 14 may optionally be used as feedback to an electronic control system to determine adjustments to the pump 8 speed. The product flow rate may also be controlled by using an in-line servo valve, an excess flow by-pass valve, or by PWM (pulse width modulation) of the spray nozzles.

### BRIEF SUMMARY

Disclosed herein are various agricultural spraying systems, and more specifically agricultural spraying systems, methods, and devices configured to overcome issues introduced by PWM (pulse width modulation) spray nozzle control systems.

In Example 1, a liquid application system comprising a nozzle comprising a pulse width modulation (PWM) nozzle valve and a spray tip and a control system in communication the nozzle configured to calculate a nozzle exit pressure and dynamically adjust nozzle settings to achieve a target nozzle exit pressure.

Example 2 relates to the liquid application system of any of Examples 1 and 3-9, wherein the control system is configured to calculate a nozzle-exit pressure based on boom pressure and valve/nozzle flow: coefficients using a combined flow coefficient, and to adjust PWM duty cycle and/or a pump speed based on the calculated nozzle-exit pressure to maintain a target droplet volume median diameter (VMD).

Example 3 relates to the liquid application system of any of Examples 1-2 and 4-9, wherein the memory stores spray tip size and reference flow rate, PWM valve flow coefficient (CVPWM), and product density, and a processor is configured to compute a nozzle flow coefficient (CVNozzle), a combined flow coefficient (CVTotal), and a nozzle-exit pressure (PNozzle) according to:

$$C {V}_{N o z z l e} = \sqrt{\frac{{GPM}_{N o z z l e}^{2}}{{P}_{R e f e r e n c e}}} ; {CV}_{Tolal} = \frac{1}{\sqrt{\frac{1}{{CV}_{Nozzle}^{2}} + \frac{1}{{CV}_{PWM}^{2}}}} ; and$$

$${P}_{N o z z l e} = {( \frac{\sqrt{{P}_{B o o m}} * C {V}_{Total}}{{CV}_{N o z z l e}} )}^{2} .$$

Example 4 relates to the liquid application system of any of Examples 1-3 and 5-9, wherein the control system is configured to log and map, for each nozzle across a boom, the calculated nozzle exit pressure and a resulting droplet size characterization.

Example 5 relates to the liquid application system of any of Examples 1˜4 and 6-9, wherein the control system is configured to implement turn compensation by adjusting PWM duty cycle on a nozzle-by-nozzle basis across the width of a boom based on calculated nozzle exit pressure.

Example 6 relates to the liquid application system of any of Examples 1-5 and 7-9, further comprising a flow meter and a pump, wherein the control system is configured to adjust pump speed in coordination with PWM duty cycles to maintain the target nozzle exit pressure.

Example 7 relates to the liquid application system of any of Examples 1-6 and 8-9, wherein the control system is configured to select a target exit pressure based on chemical type and label requirements.

Example 8 relates to the liquid application system of any of Examples 1-7 and 9, wherein the control system is configured to record nozzle-exit pressure and VMD data with geographic location information to produce spatial maps of droplet size and pressure across a field.

Example 9 relates to the liquid application system of any of Examples 1-8, further comprising a communications component configured to transmit pressure and control data from the nozzle to a tractor, display, or cloud platform for further processing and reporting.

In Example 10, a liquid application system comprising a boom plumbing configured to deliver a liquid from a tank to a plurality of spray nozzles; a nozzle body at each spray location, each nozzle body comprising a pulse width modulation (PWM) nozzle valve, a spray tip downstream of the PWM nozzle valve, and a pressure sensor disposed between the PWM nozzle valve and the spray tip configured to measure pressure of the liquid exiting the PWM nozzle valve. The liquid application system also comprising a control system in communication with the plurality of pressure sensors and the PWM nozzle valves, the control system comprising a processor and a memory storing nozzle and product attributes, wherein the control system is configured to dynamically adjust one or more spray parameters based on pressure measured between the PWM nozzle valve and the spray tip to achieve a desired spray pressure and corresponding droplet size.

Example 11 relates to the liquid application system of any of Examples 10 and 12-16, wherein the control system is configured to log and map, for each nozzle body across the boom, the measured pressure between the PWM nozzle valve and the spray tip and the resulting droplet size characterization including VMD.

Example 12 relates to the liquid application system of any of Examples 10-11 and 13-16, wherein the control system is configured to implement turn compensation by adjusting PWM duty cycle on a nozzle-by-nozzle basis across the width of the boom.

Example 13 relates to the liquid application system of any of Examples 10-12 and 14-16, further comprising a flow meter and a pump, wherein the control system is configured to adjust pump speed in coordination with PWM duty cycles to maintain target nozzle-exit pressure.

Example 14 relates to the liquid application system of any of Examples 10-13 and 15-16, wherein the control system is configured to detect deviations between boom pressure and measured nozzle-exit pressure indicative of pressure drop across the PWM valve and to compensate by adjusting one or more of PWM duty cycle, pump speed, servo bypass valve position, and ground speed.

Example 15 relates to the liquid application system of any of Examples 10-14 and 16, wherein the control system is configured to select a VMD target based on chemical type and label requirements, and to maintain the selected VMD by closed-loop control of nozzle-exit pressure.

Example 16 relates to the liquid application system of any of Examples 10-15, wherein the control system is configured to record nozzle-exit pressure and VMD data with geographic location information to produce spatial maps of droplet size and pressure across the field.

In Example 17, a method of controlling droplet size in an agricultural spraying system comprising delivering liquid from a tank through boom plumbing to a plurality of nozzle bodies, each nozzle body comprising a PWM nozzle valve and a spray tip; measuring or calculating a pressure of liquid exiting the PWM nozzle valve; and dynamically adjusting one or more spray parameters comprising PWM duty cycle, pump speed, and/or servo bypass valve position to achieve a target nozzle-exit pressure corresponding to a desired droplet volume median diameter.

Example 18 relates to the method of any of Examples 17 and 19-20, further comprising storing nozzle and product attributes including spray tip size, reference flow rate, PWM valve flow coefficient, and product density.

Example 19 relates to the method of any of Examples 17-18 and 20, further comprising mapping and logging nozzle-exit pressure and VMD data on a nozzle-by-nozzle basis across the boom with associated geographic position information.

Example 20 relates to the method of any of Examples 17-19, further comprising selecting a droplet size profile based on chemical type and controlling nozzle-exit pressure to maintain VMD within a profile-defined band.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is an exemplary schematic diagram of an agricultural sprayer, according to one implementation.

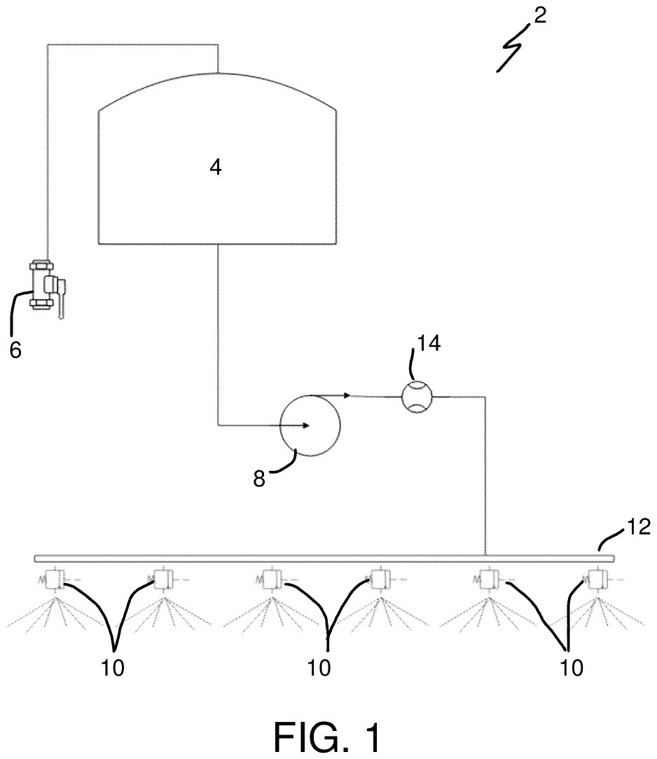

FIG. 2 is a diagram showing exemplary spray droplet coverage distance based on size, according to one implementation.

FIG. 3 is a sprayer system diagram, according to one implementation.

FIG. 4 is a sprayer system diagram, according to one implementation.

FIG. 5 is a spray nozzle and system diagram, according to one implementation.

### DETAILED DESCRIPTION

Disclosed herein are various devices, systems, and methods that provide the ability to measure and/or calculate the pressure drop at the PWM nozzle valve and control a sprayer and associated systems based upon the measured and/or calculated pressure after the PWM nozzle valve. That is, the disclosed systems, methods, and devices are configured to result in spraying with the correct VMD and properly mapping and logging VMD and actual nozzle pressure.

Disclosed devices, systems, and methods provide direct measurement and/or calculation of pressure at the nozzle exit downstream of a PWM nozzle valve and use the result to control sprayer operation such that spraying occurs at an intended VMD, with accurate logging and mapping of VMD and actual nozzle pressure.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. Pat. No. 12,353,210, issued Jul. 8, 2025, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. Pat. No. 12,268,115, issued Apr. 8, 2025, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. Pat. No. 12,414,505, issued Sep. 16, 2025, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/556,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. Pat. No. 12,403,950, issued Sep. 2, 2025, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/766,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices and Methods,” U.S. patent application Ser. No. 19/305,530, filed Aug. 20, 2025, entitled “Crop Sensor Wands and Related Devices, Systems, and Methods,” U.S. patent application Ser. No. 19/366,202, filed Oct. 22, 2025, entitled “Crop Sensors and Related Devices, Systems, and Methods,” U.S. patent application Ser. No. 19/367,363, filed Oct. 23, 2025, entitled “Agricultural Sprayer Sensor and Related Devices, Systems, and Methods,” U.S. patent application Ser. No. 19/390,280, filed Nov. 14, 2025, entitled “Liquid Product Distribution for Agricultural Spraying Systems and Related Devices and Methods,” U.S. Patent Application 63/722,916, filed Nov. 20, 2024, entitled “Agricultural Harvesting Systems and Related Devices and Methods,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/727,579, filed Dec. 3, 2024, entitled “Smart Shift for Automatic AB Line Adjustment in Agricultural Operations and Related Devices and Methods,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” U.S. Patent Application 63/906,692, filed Oct. 28, 2025, entitled “Agricultural Alignment System and Related Devices and Methods,” and U.S. Patent Application 63,906,646, filed Oct. 28, 2025, entitled “Automated Grail Filling System and Related Devices and Methods,” each of which is incorporated herein by reference.

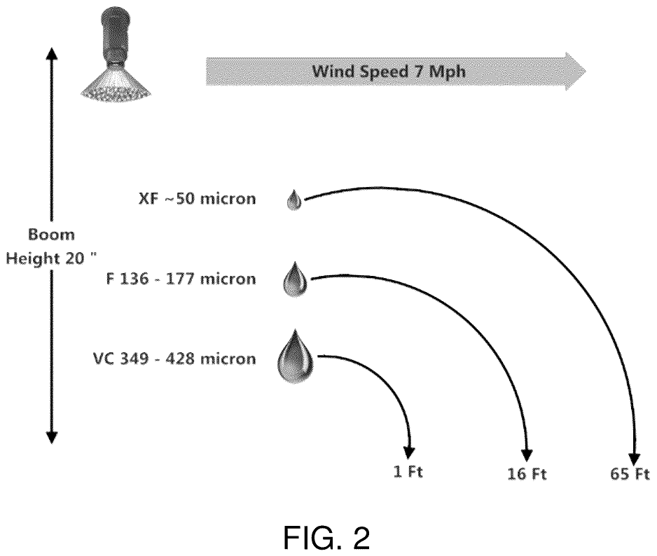

Spray droplet size, optionally quantified as Volume Median Diameter (VMD), is important to sprayer efficacy and operation. As used herein, VMD refers to the midpoint droplet size (median), where half of the volume of spray is in droplets smaller than the VMD, and half of the volume is in droplets larger than the VMD. As would be generally understood, VMD and other properties of spray nozzles are typically published in the spray nozzle manufacturer's literature. Spray drift and off-site application are dependent upon VMD as illustrated by FIG. 2. That is, the distance a spray droplet will travel will vary based on the droplet size, with smaller droplets traveling farther than larger droplets. Wind speed, boom height, and other factors may also have an effect on spray coverage including coverage of undesired/unintended areas.

As would be appreciated, and as used herein, a contact pesticide is a pesticide that kills on contact. That is, the pest does not have to ingest the chemical to be terminated. A systemic pesticide is a pesticide that is absorbed by and transported through the plant to which it is applied, such that the plant is toxic to pests that feed on the plant.

Chemical efficacy-how well the pesticide/treatment is able to produce the desired effect—is at least partially dependent upon spray droplet size (VMD). In general contact pesticides need to be sprayed with a smaller VMD, while systemic pesticides are sprayed at larger VMD to maximize efficacy.

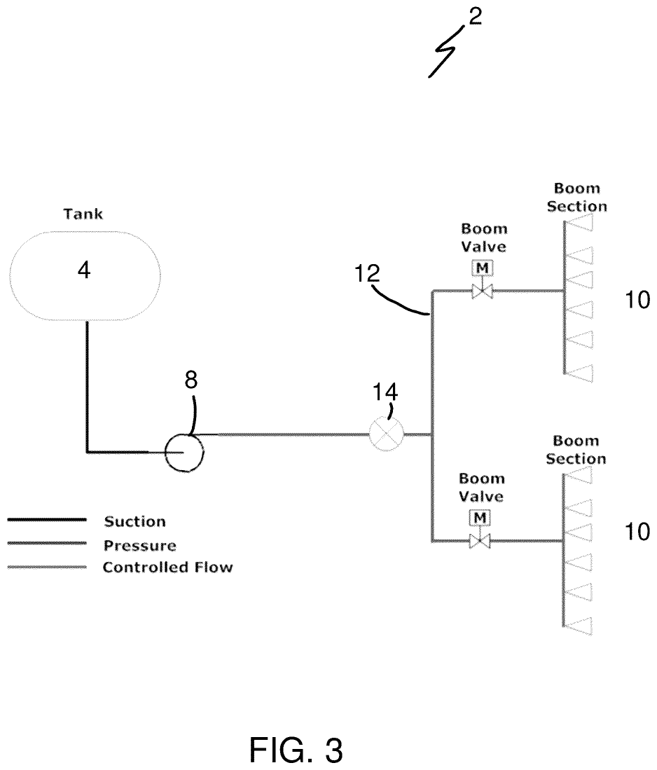

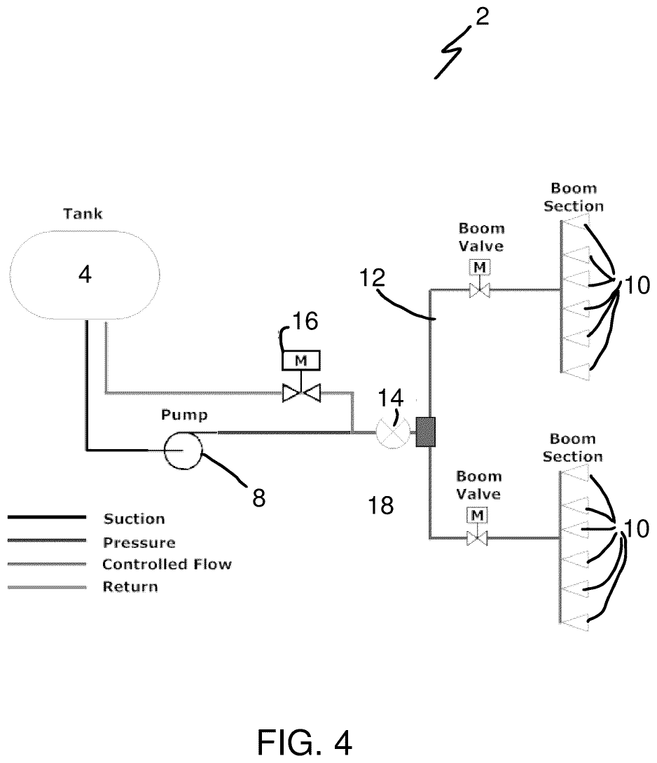

Various sprayer control systems may adjust the product application rate by increasing or decreasing the volume of product flowing to the boom 12 and ultimately being discharged through the spray nozzles 10 by various devices and system controls, examples of which are shown in FIGS. 3 and 4.

For example, FIG. 3 shows a sprayer 2 that varies the speed of the product pump 8 to adjust product flow rate. The flow rate may optionally be controlled using feedback from a flow meter 14.

In another example, shown in FIG. 4, the sprayer 2 that uses a constant speed pump 8, where product flow rate to the boom 12 is varied by a motorized servo valve 16 that returns excess product volume back to the product tank 4.

As product flow rate increases spray nozzle 10 pressure increases. As product flow rate decreases spray nozzle 10 pressure decreases.

The following formulas may be used to determine pressure and nozzle flow rate based upon application of water (density 8.34 pounds per US gallon) and may be converted using the conversion factor described. A liquid density conversion factor is required for products with specific gravity different than that of water. This conversion factor may be calculated using Equation 1.

$$\begin{matrix}Equation 1 ; Liquid Density Conversion Factor & \\ F = Conversion Factor & \end{matrix}$$

$$X = Weight of Product in Pounds / US Gallon$$

$$F = \sqrt{\frac{X}{8.34}}$$

This conversation factor can be applied to the flow rate for liquids with a specific gravity different than water for calculating boom pressure and controlling application rate based upon pressure transducer feedback, as described herein. The relationship between pressure and nozzle flow rate is calculated using Equation 2.

$$\begin{matrix}Equation 2 : Pressure and Flow Relationship & \\ GPM = Gallons Per Minute Per Nozzle & \end{matrix}$$

$$PSI = Pressure at Spray Nozzle$$

$$\frac{{GPM}_{1}}{{GPM}_{2}} = \frac{\sqrt{{PSI}_{1}}}{\sqrt{√ {PSI}_{2}}}$$

Nozzle flow rate is calculated using Equation 3.

$$\begin{matrix}Equation 3 ; Nozzle Flow Rate Calculation & \\ GPM = Gallons Per Minute Per Nozzle & \end{matrix}$$

$$GPA = Gallons Per Acre , Application Rate$$

$$MPH = Miles Per Hour , Sprayer Ground Speed$$

$$W = Nozzle Spacing in Inches$$

$$GPM = \frac{GPA \times MPH \times W}{5940}$$

Nozzle pressure may also controlled based upon flow sensor/flow meter 14 feedback and/or ground speed feedback. For example, as ground speed increases, nozzle pressure may be increased. Likewise, as ground speed is decreased, nozzle pressure may be decreased.

A change in nozzle pressure results in change to the VMD. As such, the VMD can be adjusted by changing nozzle pressure, such as by adjusting pump speed or flow rate.

Various sprayers 2 may include a nozzle-by-nozzle pulse width modulation (PWM) control system 100 allowing for control of application rate and boom nozzle pressure independent of each other. This type of system 100 allows for more consistent and precise rate control, support for turn compensation of the application rate on a nozzle-by-nozzle level across the width of the boom, and support for spraying at consistent pressure which results in a consistent VMD. Consistent VMD may result in less chemical drift/off-site application, better chemical efficacy, and increased range of operating speeds.

One result of using a PWM valve is that there can be a significant pressure drop at the PWM valve nozzle, resulting in spraying at a lower pressure than what would be anticipated by the boom pressure. Boom pressure may be measured by a pressure sensor (shown at 18 in FIG. 4) located just prior to the boom 12 in the plumbing of the sprayer 2. This pressure drop results in a larger spray droplet, VMD, than expected, resulting incorrect application, poor weed/pest control, and/or other negative effects, as would be understood. In addition, the logged data for spray pressure and VMD would be incorrect for PWM valve applications.

The disclosed devices, systems, and methods provide the ability to measure and/or calculate the pressure drop at the PWM nozzle valve and control the sprayer 2 based upon the measured and/or calculated pressure at the PWM nozzle valve. That is, the disclosed systems, methods, and devices result in spraying with the correct VMD and properly mapping and logging VMD and actual nozzle pressure.

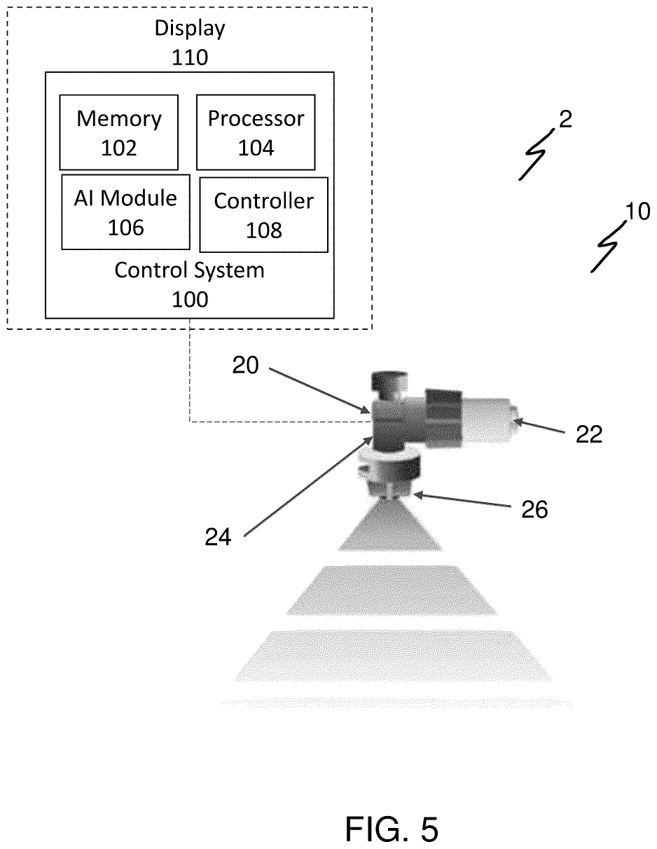

Turning now to FIG. 5, in various implementations the disclosed devices, systems, and methods include a nozzle 10 having one or more pressure sensors 24 in a nozzle body 20 after the PWM nozzle valve 22 and before the spray tip 26. In various implementations, the sprayer 2 system 100 includes a pressure sensor 24 in each nozzle body 20 along the boom 12 to support turn compensation and/or multiple application rates across the width of the boom 12. If turn compensation, nozzle-by-nozzle on/off based upon prior coverage, or multiple rates across the boom 12 are not required, then a pressure sensor 24 could be in a single nozzle body 20. Optionally, a pressure sensor 24 may be installed variously across the boom 12 in more than one but less than all nozzle bodies 20.

In various implementations, the pressure sensor 24 is configured to sense the pressure of the fluid upon exiting the nozzle valve 22 and before entering the spray tip 26.

In various implementations, the pressure sensor 24 is in communication with a control system 100 to communicate the sensed pressure for logging and reporting, such as in a memory 102. Various decisions may be made based on the pressure sensor data including adjustments to the fluid distribution system, repairs, reapplication, and the like, as would be understood. Decisions may be made by calculations, and other processing steps executed by a processor 104. In various implementations, the decision may be made automatically or semi-automatically with some, minimal, or no input from an operator.

The control system 100 comprises one or more processors 104, memory 102 storing nozzle and valve attributes (including flow coefficients), sensor inputs, and control software, and I/O interfaces to actuators such as PWM drivers, pump controllers, and servo valves. The control system 100, in various implementations, executes a real-time feedback loop that compares sensed or calculated nozzle-exit pressure to a target pressure corresponding to a desired VMD. The loop generates control outputs to adjust PWM duty cycle, pump speed, and/or servo valve position to converge the nozzle-exit pressure to the target value. The loop may incorporate feedforward terms derived from ground speed, commanded application rate (GPA), and product attributes (e.g., density) to improve response and stability.

In certain implementations, the pressure sensor data may to analyzed by a machine learning model 106, such as may be in an artificial intelligence (AI) model 106, to aid in decision making as would be understood.

In various further implementations, the pressure may be calculated by mathematically calculating the pressure drop and resulting nozzle 10 pressure using the following information and formulas:

$$G P M = {C}_{v} \times √ Δ P$$

$$Δ P = {( \frac{G P M}{{C}_{v}} )}^{2}$$

$${C}_{ν T o t a l} = \frac{1}{\sqrt{\frac{1}{{C}_{v 1}^{2}}} + \frac{1}{{C}_{v 2}^{2}}}$$

In these and other implementations, spray nozzle 10 attributes are stored within the control system 100 memory 102 and/or may be manually entered by the user at time of operation. Nozzle attributes may include: spray tip size, PWM nozzle valve CV, where CV represents the flow rate of water in gallons per minute at 60° F. that produces a pressure drop of 1 PSI across a valve or orifice, and other attributes as would be understood.

The spray pressure, after the PWM valve and the spray nozzle can be calculated using the following equations.

$$\begin{matrix}Equation 4 : Calculating CV Value for Spray Nozzle & \\ {CV}_{Nozzle} = \sqrt{\frac{{GPM}_{Nozzle}^{2}}{{P}_{Reference}}} & \end{matrix}$$

CV_{Nozzle}=CV value for the spray nozzle in use. This may be calculated using nozzle manufacturer supplied data.

GPM_{Nozzle}=Flow rate of a spray nozzle at a reference pressure. This value may be supplied by the spray nozzle manufacturer.

P_{Reference}=Reference pressure PSI used for a specified nozzle flow rate. This value may be supplied by the spray nozzle manufacturer.

$$\begin{matrix}Equation 5 : Calculating Total CV & \\ {CV}_{Total} = \frac{1}{\sqrt{\frac{1}{{CV}_{Nozzle}^{2}} + \frac{1}{{CV}_{PWM}^{2}}}} & \end{matrix}$$

CV_{Total}=A calculated value representing the combined CV for both the spray nozzle and the PWM valve.

CV_{PWM}=CV value for the PWM nozzle valve. This value may be supplied by the PWM nozzle valve manufacturer.

$$\begin{matrix}Equation 6 : Calculating Spray Nozzle Pressure & \\ {P}_{N o z z l e} = {( \frac{\sqrt{{P}_{B o o m}} * C {V}_{Total}}{C {V}_{N o z z l e}} )}^{2} & \end{matrix}$$

P_{Boom}=Spray Boom pressure

P_{Nozzle}=Resulting pressure PSI exiting the spray nozzle after pressure drop through PWM valve and spray nozzle.

Product attributes may be stored within the control system 100 memory 102 and/or manually entered by the user at time of operation. These attributes may include product density and viscosity, among others as would be understood and appreciated.

Optionally using a feedback control loop various data is supplied in real-time by the liquid system application controller 108. This data may include product flow rate, boom pressure, application rate/area, ground speed, spray path curvature, and PWM nozzle duty cycle.

By knowing the actual pressure at the nozzle 10, determined by calculation and/or direct measurement, the system 100 is capable of controlling various components of the sprayer 2 to apply liquids with the correct pressure and VMD, resulting in increased efficacy.

Additionally, the described system 100 allows for more accurate logging and mapping of VMD and nozzle pressure. Further the described system, methods, and devices allow for increased compliance with restricted use pesticide (RUP) label requirements.

In various implementations, the sprayer 2 and system 100 include various software, hardware, and firmware components needed to execute the programs and methods of the system. Optionally, the sprayer 2 and system 100 may include a communications component configured to convey data from the sensors to a tractor/display/cloud for further processing by the processor 104.

The control system 100 may optionally be housed in a display 110 that may optionally include a communications component configured to send and receive instructions for operation of the system, sprayer, and components thereof. The display may also optionally include a graphical user interface (GUI), a memory/storage 102, a global positioning system (GPS), and other components necessary to effectuate the methods of the system 100.

The disclosure addresses pressure-drop effects introduced by PWM nozzle valves and provides architectures for direct measurement and/or calculated estimation of nozzle-exit pressure to control, log, and map spray pressure and volume median diameter (VMD) with improved accuracy. Implementations include integrated sensor modules within nozzle bodies, distributed control systems executing real-time feedback loops, and signal processing routines using manufacturer-specified valve and nozzle coefficients to compute pressure after the PWM valve. The disclosed systems operate in conjunction with ground vehicle platforms (e.g., tractors, self-propelled sprayers) and sprayer booms, and are configured to control and adjust hardware components such as pumps, servo valves, and nozzle PWM duty cycles to maintain target pressure and VMD across dynamic operating conditions, including variable ground speed, turn events, and product density changes. By providing specific machine-implemented control logic tied to physical components and sensory inputs, the disclosure enhances the functional operation of agricultural sprayers, mitigates drift and off-target application, increases chemical efficacy for contact and systemic products, and improves compliance with product label requirements.

Although the disclosure has been described with references to various embodiments, persons skilled in the art will recognize that changes may be made in form and detail without departing from the spirit and scope of this disclosure.

What is claimed is:

1. A liquid application system comprising:
(a) a nozzle comprising:
(i) a pulse width modulation (PWM) nozzle valve; and
(ii) a spray tip; and
(b) a control system in communication the nozzle configured to calculate a nozzle exit pressure and dynamically adjust nozzle settings to achieve a target nozzle exit pressure.

2. The liquid application system of claim 1, wherein the control system is configured to calculate a nozzle-exit pressure based on boom pressure and valve/nozzle flow coefficients using a combined flow coefficient, and to adjust PWM duty cycle and/or a pump speed based on the calculated nozzle-exit pressure to maintain a target droplet volume median diameter (VMD).

3. The liquid application system of claim 1, wherein the memory stores spray tip size and reference flow rate, PWM valve flow coefficient (CV_{PWM}), and product density, and a processor is configured to compute a nozzle flow coefficient (CV_{Nozzle}), a combined flow coefficient (CV_{Total}), and a nozzle-exit pressure (P_{Nozzle}) according to:
$$C {V}_{N o z z l e} = \sqrt{\frac{{GPM}_{N o z z l e}^{2}}{{P}_{R e f e r e n c e}}} ; {CV}_{Tolal} = \frac{1}{\sqrt{\frac{1}{{CV}_{Nozzle}^{2}} + \frac{1}{{CV}_{PWM}^{2}}}} ; and$$
$${P}_{N o z z l e} = {( \frac{\sqrt{{P}_{B o o m}} * C {V}_{Total}}{{CV}_{N o z z l e}} )}^{2} .$$

4. The liquid application system of claim 1, wherein the control system is configured to log and map, for each nozzle across a boom, the calculated nozzle exit pressure and a resulting droplet size characterization.

5. The liquid application system of claim 1, wherein the control system is configured to implement turn compensation by adjusting PWM duty cycle on a nozzle-by-nozzle basis across the width of a boom based on calculated nozzle exit pressure.

6. The liquid application system of claim 1, further comprising a flow meter and a pump, wherein the control system is configured to adjust pump speed in coordination with PWM duty cycles to maintain the target nozzle exit pressure.

7. The liquid application system of claim 1, wherein the control system is configured to select a target exit pressure based on chemical type and label requirements.

8. The liquid application system of claim 1, wherein the control system is configured to record nozzle-exit pressure and VMD data with geographic location information to produce spatial maps of droplet size and pressure across a field.

9. The liquid application system of claim 1, further comprising a communications component configured to transmit pressure and control data from the nozzle to a tractor, display, or cloud platform for further processing and reporting.

10. A liquid application system comprising:
(a) a boom plumbing configured to deliver a liquid from a tank to a plurality of spray nozzles;
(b) a nozzle body at each spray location, each nozzle body comprising:
(i) a pulse width modulation (PWM) nozzle valve;
(ii) a spray tip downstream of the PWM nozzle valve; and
(iii) a pressure sensor disposed between the PWM nozzle valve and the spray tip configured to measure pressure of the liquid exiting the PWM nozzle valve; and
(c) a control system in communication with the plurality of pressure sensors and the PWM nozzle valves, the control system comprising:
(i) a processor and
(ii) a memory storing nozzle and product attributes,
wherein the control system is configured to dynamically adjust one or more spray parameters based on pressure measured between the PWM nozzle valve and the spray tip to achieve a desired spray pressure and corresponding droplet size.

11. The liquid application system of claim 10, wherein the control system is configured to log and map, for each nozzle body across the boom, the measured pressure between the PWM nozzle valve and the spray tip and the resulting droplet size characterization including VMD.

12. The liquid application system of claim 10, wherein the control system is configured to implement turn compensation by adjusting PWM duty cycle on a nozzle-by-nozzle basis across the width of the boom.

13. The liquid application system of claim 10, further comprising a flow meter and a pump, wherein the control system is configured to adjust pump speed in coordination with PWM duty cycles to maintain target nozzle-exit pressure.

14. The liquid application system of claim 10, wherein the control system is configured to detect deviations between boom pressure and measured nozzle-exit pressure indicative of pressure drop across the PWM valve and to compensate by adjusting one or more of PWM duty cycle, pump speed, servo bypass valve position, and ground speed.

15. The liquid application system of claim 10, wherein the control system is configured to select a VMD target based on chemical type and label requirements, and to maintain the selected VMD by closed-loop control of nozzle-exit pressure.

16. The liquid application system of claim 10, wherein the control system is configured to record nozzle-exit pressure and VMD data with geographic location information to produce spatial maps of droplet size and pressure across the field.

17. A method of controlling droplet size in an agricultural spraying system comprising:
delivering liquid from a tank through boom plumbing to a plurality of nozzle bodies, each nozzle body comprising a PWM nozzle valve and a spray tip;
measuring or calculating a pressure of liquid exiting the PWM nozzle valve; and
dynamically adjusting one or more spray parameters comprising PWM duty cycle, pump speed, and/or servo bypass valve position to achieve a target nozzle-exit pressure corresponding to a desired droplet volume median diameter.

18. The method of claim 17, further comprising storing nozzle and product attributes including spray tip size, reference flow rate, PWM valve flow coefficient, and product density.

19. The method of claim 17, further comprising mapping and logging nozzle-exit pressure and VMD data on a nozzle-by-nozzle basis across the boom with associated geographic position information.

20. The method of claim 17, further comprising selecting a droplet size profile based on chemical type and controlling nozzle-exit pressure to maintain VMD within a profile-defined band.
